(19) United States
(12) Patent Application Publication
(10) Pub. No.: US 2022/0080564 A1
(43) Pub. Date: Mar. 17, 2022

(54) Hinge Structure of Hand Tool

(71) Applicant: KABO Tool Company, Taichung City (TW)

(72) Inventor: Chih-Ching Hsieh, Taichung City (TW)

(73) Assignee: KABO Tool Company

(21) Appl. No.: 17/444,945

(22) Filed: Aug. 12, 2021

(30) Foreign Application Priority Data
Sep. 11, 2020 (TW) 109131281

(51) Int. Cl. B25B 23/00; B25B 13/04

(52) U.S. Cl. CPC B25B 23/0028; B25B 13/04

(57) ABSTRACT

A hinge structure of a hand tool includes a first connector having a first connecting portion; a second connector having a second connecting portion; and a shaft having one end formed of a stopping portion protruded therefrom and another end having a locking slot formed thereon. The locking slot includes a locking member elastically locked thereon. The shaft penetrates through the first connecting portion and the second connecting portion. In addition, the locking member is locked inside the locking slot, such that the locking member and the stopping portion are locked at the outer side of the first connecting portion and the second connecting portion. Accordingly, the engagement area between the shaft and the first connector and the second connector is able to provide a greater strength.

### BACKGROUND OF THE INVENTION

### 1. Technical Field

The present invention is related to a hand tool, and in particular, to a hinge structure of a hand tool capable of increasing the strength of the hinge portion of the hand tool.

### 2. Description of Related Technology

With regard to a known hand tool, FIG. 1 illustrates a known hand tool 90 having a movable structure that can be adjusted to different angles. The hand tool 90 includes a head portion 91 and a handle portion 92. The engagement area between the head portion 91 and the handle portion 92 is formed of at least one through hole 911/921 overlapping with each other respectively. In addition, it also includes a shaft 93 penetrating through each one of the through holes 911/921 in order to allow the head portion 91 and the handle portion 92 to rotate relative to each other with the shaft 93 as the axis of rotation, thereby adjusting the angle of rotation. To prevent looseness or disengagement of the shaft 93, one end of the shaft 93 includes a retaining piece 931, and another end includes a screw hole 932, and a screw 933 is fastened into the screw hole of the shaft 93. With the retaining piece 931 and the screw 933, the shaft 93 can be assembled onto the hand tool 90. In addition, an angle adjustment can be achieved between the head portion 91 and the handle portion 92.

When a force is exerted to the hand tool 90, the force exertion direction is generally perpendicular to the shaft 93; therefore, shear stress is likely to be generated in the radial direction, and in particular, at the engagement area between the head portion 91 and the handle portion 92. In addition, the screw hole 932 inside the shaft 93 is able to penetrate through the engagement area between the head portion 91 and the handle portion such that the strength of the shaft 93 at the area of force exertion is relatively low. Consequently, damage or deformation of the shaft 93 is likely to occur after a long period of use, leading to failure of bending of the hand tool 90 or disengagement between the head portion 91 and the handle portion 92.

### BRIEF SUMMARY OF THE INVENTION

A primary objective of the present invention is to provide a hand tool capable of enhancing the strength of the hinge portion of the hand tool.

To achieve the aforementioned objective, the present invention provides a hinge structure of a hand tool, comprising:

a first connector having a first connecting portion; the first connecting portion having at least one first lug;

a second connector having a second connecting portion; the second connecting portion having at least one second lug;

a shaft having one end formed of a stopping portion protruded therefrom and another end circumferentially formed of a locking slot; the locking slot having a locking member elastically locked thereon; the locking member arranged to elastically locked inside the locking slot, thereby allowing the locking member and the stopping portion to lock onto outer most sides of the first connecting portion and the second connecting portion.

Preferably, the shaft includes an attachment slot; an anti-dust cover having an attachment rod and a cover portion; the attachment rod is arranged inside the attachment slot such that the cover portion is able to cover the shaft; a depth of the attachment slot is shorter than a length of the first through hole or the second through hole connected thereto.

Preferably, the stopping portion includes a force exertion surface formed thereon.

For the hinge structure of a hand tool provided by the present invention, its first connector and the second connector are hinged to each other via the shaft, and the shaft has a relatively greater structural strength between the first connector and the second connector.

### BRIEF DESCRIPTION OF THE SEVERAL VIEWS OF THE DRAWINGS

To further illustrate the objectives, technical features and technical effects of the present invention, five preferred embodiments are explained in the following along with the accompanied drawings:

FIG. 1 is a cross sectional view of the hinge area of a known hand tool;

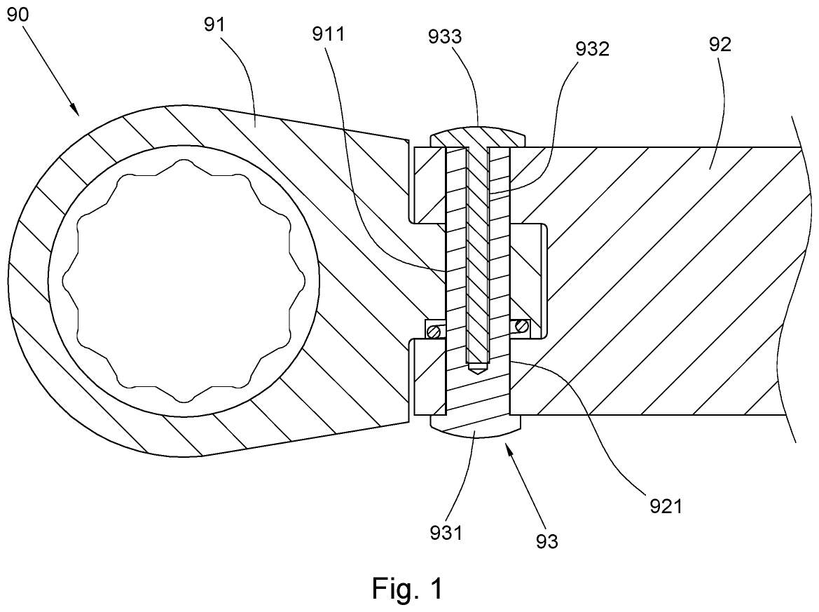

FIG. 2 is a perspective appearance view of the hand tool according to a preferred embodiment of the present invention;

FIG. 3 is a perspective exploded view of the hand tool according to a preferred embodiment of the present invention;

FIG. 4 is a perspective exploded view of the hand tool according to a preferred embodiment of the present invention viewed from another direction;

FIG. 5 is a cross sectional view of the hand tool according to a preferred embodiment of the present invention;

FIG. 6 is a cross sectional view showing the hinge area of the hand tool according to a second embodiment of the present invention viewed from an angle similar to that of FIG. 5;

FIG. 7 is a cross sectional view showing the hinge area of the hand tool according to a third embodiment of the present invention viewed from an angle similar to that of FIG. 5;

FIG. 8 is a perspective appearance view of the hand tool having different force exertion surfaces according to a fourth embodiment of the present invention; and

FIG. 9 is a cross sectional view showing the hinge area of the hand tool according to a fifth embodiment of the present invention viewed from an angle similar to that of FIG. 5.

### DETAILED DESCRIPTION OF THE INVENTION

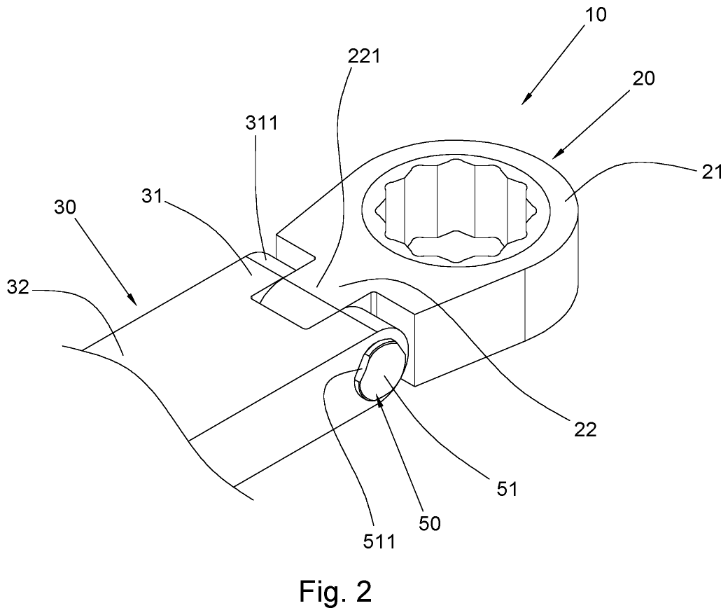

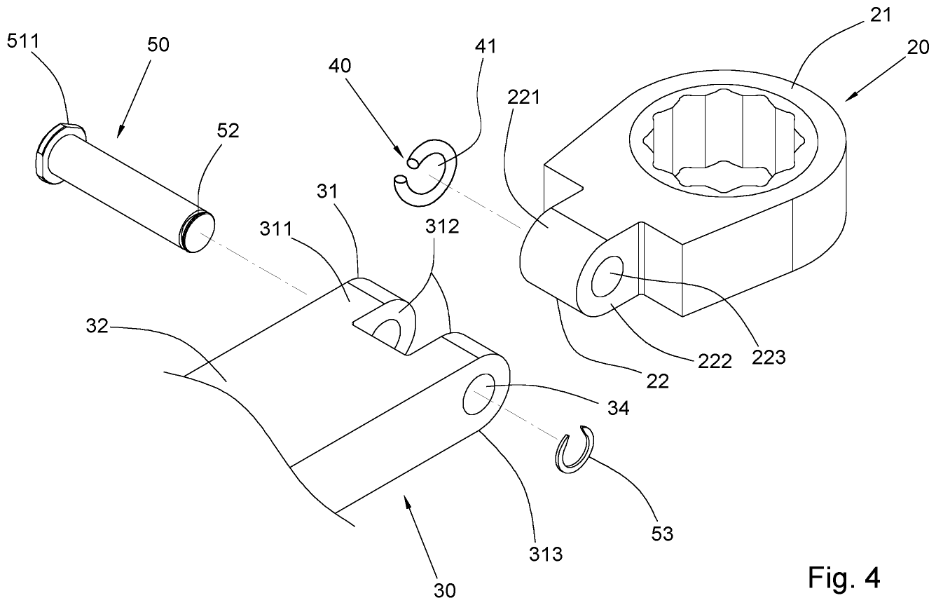

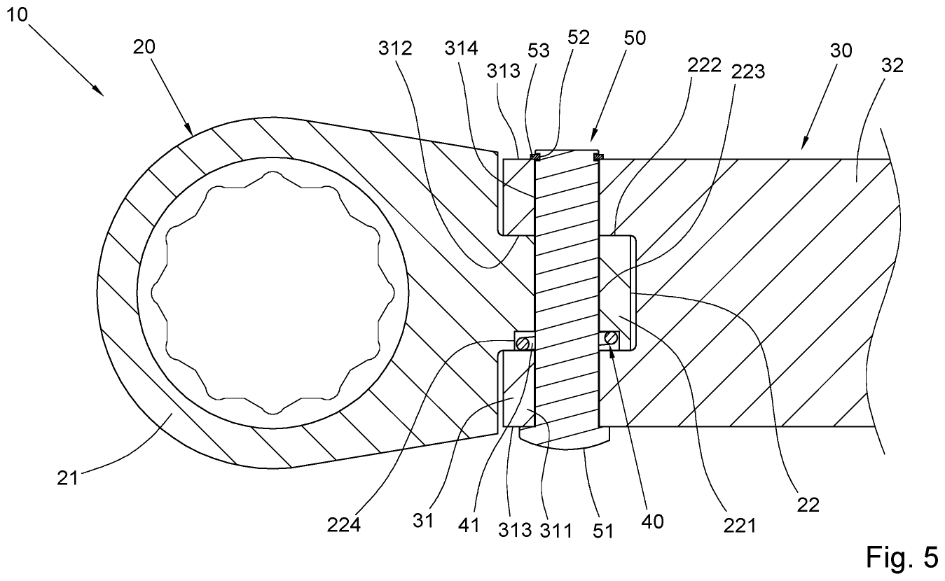

Please refer to FIG. 2 to FIG. 5, showing a hand tool 10 according to a preferred embodiment of the present invention, comprising the following elements and technical features.

A first connector 20 includes a front end formed of a head portion 21 and a rear end having a first connecting portion 22 formed thereon. The head portion 21 may include a polygonal slot or a polygonal protruding column such that it is able to facilitate the fastening and unfastening actions performed on a workpiece; in addition, a socket or other devices may also be mounted thereon for force exertion, and the present invention is not limited to such configuration only. Nevertheless, since such part is a known structure, details thereof is omitted hereafter. The first connecting portion 22 includes a first lug 221, and the first lug 221 also includes a planar first connecting 222 formed at two sides thereof respectively. A first through hole 223 is formed between the two first connecting surfaces 222 and penetrating therethrough. Furthermore, one of the first connecting surfaces 222 includes a receiving slot 224 formed to indent inward thereon. The receiving slot 224 is arranged concentrically with the first through hole 223.

A second connector 30 includes a front end having a second connector 31 and its rear end includes a handle portion 32. The second connecting portion 31 includes two second lugs 311 arranged spaced apart from each other. The second lug 311 and first lug 221 of the first connecting portion 22 of the first connector 20 are arranged between the two second lugs 311. The engagement side between the two second lugs 311 and the first lug 211 is formed of a planar second connecting surface 312. The outer side of the two second lugs not engaging with the first lug 311 is formed of a planar installation surface 313. The two second lugs 311 include a second through hole 314 respectively formed between the second connecting surface 312 and the installation surface 313 and penetrating therethrough.

An elastic member 40 is an elastic gasket arranged inside the receiving slot 224 of the first connecting portion 22 of the first connector 20. The center of the elastic member 40 further includes a through hole 41 penetrating therethrough.

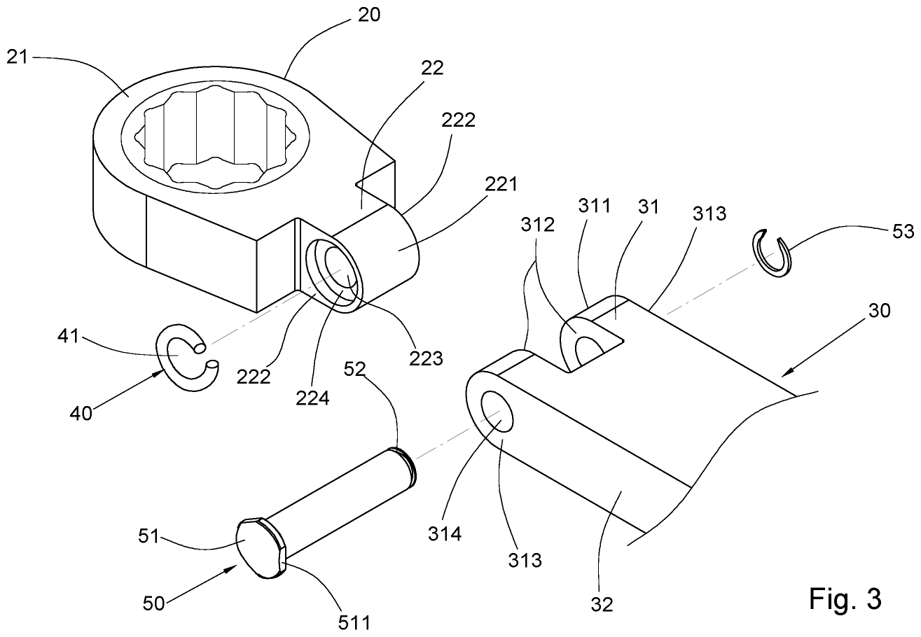

A shaft 50, as shown in FIG. 3, is a solid circular column, and it includes one end having a stopping portion 51 formed to protrude therefrom. The stopping portion 51 includes a force exertion surface 511 formed thereon. The force exertion surface 511 is arranged at the tangential surface of the outer circumference of the stopping portion 51 such that it may be provided for retaining with a tool, thereby preventing the shaft 50 from rotating. Furthermore, the structure of the force exertion surface 511 is not limited to any specific configuration. Another end of the shaft 50 includes a locking slot 52 formed at the outer circumference adjacent to the rear end. A locking member 53 is elastically locked inside the locking slot 52. When the locking member 53 is locked inside the locking slot 52, the locking member 53 protrudes out of the shaft 50 such that the shaft 50 is prevented from falling off or disengagement.

As shown in FIG. 3 to FIG. 5, during the engagement of the first connector 20 and the second connector 30 of the hand tool 10, the first connecting portion 22 of the first connector 20 is aligned with the second connecting portion 31 of the second connector 30 first. Accordingly, the first lug 221 of the first connecting portion 22 is arranged between the two second lugs 311 of the second connecting portion 31, the two first connecting surfaces 222 are arranged opposite from the two second connecting surfaces 312, and the two second through holes 314 are arranged coaxially with the first through hole 223. Next, the shaft 50 penetrates through from the installation surface of the second lug 311, such that the shaft 50 is able to penetrate through the second through hole 314 in order to further penetrate through the through hole 41 of the elastic member 40. In addition, after penetrating through the first through hole 223, it then penetrates through another second through hole 314, thereby allowing the stopping portion 51 of the shaft 50 to be blocked at the installation surface 313. Furthermore, the locking slot 52 of the shaft 50 is located at the outer side of another installation surface 313. Moreover, the locking member 53 is elastically locked inside the locking slot 52 such that the two ends of the shaft member 50 are respectively locked onto the two installation surfaces 313 at the outer side of the two second lugs 311. Consequently, the first connector 20 is able to rotate relative to the second connector 30 with the shaft 50 as the axis of rotation. Once the angle of rotation is adjusted in position, the elastic member 40 is able to generate an elastic retaining force on the shaft 50, thereby maintaining the adjustment position of the first connector 20 and the second connector 30, and the user is able to hold the handle portion 32 to exert an acting force on the head portion 21.

When a force is exerted on the hand tool 10, since the center of the shaft 50 is a solid circular column, at the area between the two first connecting surfaces 222 of the first connecting portion 22 and the two second connecting surfaces 312 of the second connecting portion 31, the shaft 50 is able to withstand a relatively greater shear force of exertion, and the shaft 50 cannot be damaged easily

When the shaft 50 is to be removed, a tool can be used for securement on the force exertion surface 511 such that the shaft 50 cannot be rotated, following which the locking member 53 can be removed, such that the locking slot 52 end of the shaft 50 is smaller than the first through hole 223 and the two through holes 314. Consequently, the shaft 50 can then be removed.

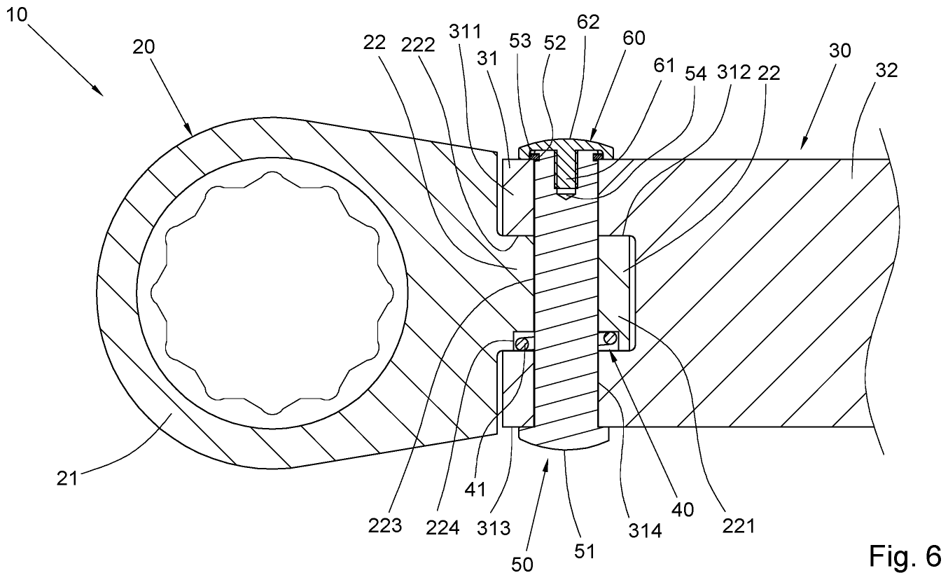

Please refer to FIG. 6, showing a second preferred embodiment of the present invention, and its main structure is identical to that of the first embodiment. In addition, for identical components, the same component signs are used accordingly, and details thereof are omitted hereafter.

The shaft 50 includes an attachment slot 54 formed at the end of the locking slot 52 in an axial direction. The depth of the attachment slot 54 is smaller than the thickness of the second lug 311 of the second connecting portion 31. In this embodiment, the internal of the attachment slot 54 is formed of inner threads. An anti-dust cover 60 includes an attachment rod 61 and a cover portion 62. The center of the cover portion 62 is attached to the attachment rod 61. The attachment rod 61 is formed of outer threads correspondingly in order to be fastened into the attachment slot 54 of the shaft 50. In terms of implementation in practice, the attachment rod 61 and the attachment slot 54 may adopt the press-fit attachment method in order to press fit the attachment rod 61 into the attachment slot 54. Alternatively, other attachment methods may also be adopted as long as the cover portion 62 is able to cover the outer side of the shaft 50. The cover portion 62 is able to prevent dust from entering the area between the shaft 50 and the second through hole 314. In addition, since the depth of the attachment slot 54 does not reach the location where the second connecting surface 312 engages with the first connecting surface 222, the shaft 50 is able to maintain a relatively greater strength at the location where shear stress is generated, thereby maintaining its strength without being damaged easily.

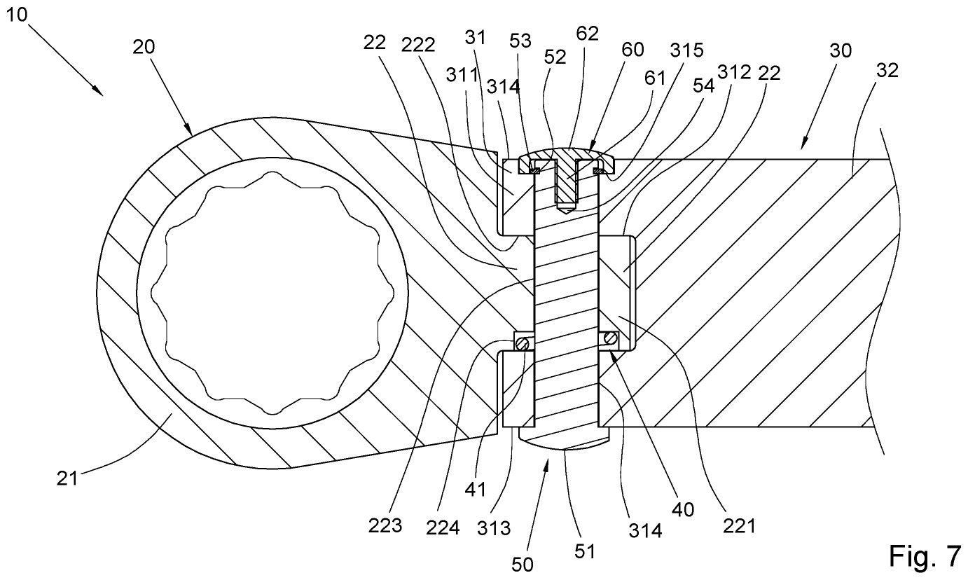

Please refer to FIG. 7, showing a third preferred embodiment of the present invention, and its main structure is identical to that of the first embodiment. In addition, for identical components, the same component signs are used accordingly, and details thereof are omitted hereafter.

An installation surface 313 of the second connector 30 includes a groove 315 formed to indent inward thereon. The groove 315 is arranged coaxially with the second through hole 314. The locking slot 52 of the shaft 50 is located at the bottom of the groove 315 such that during the assembly of the locking member 53, it is locked at the bottom of the groove 315. In addition, the cover portion 62 of the anti-dust cover 60 is also embedded inside the groove 315, thereby increasing the isolation effect of the anti-dust cover 60.

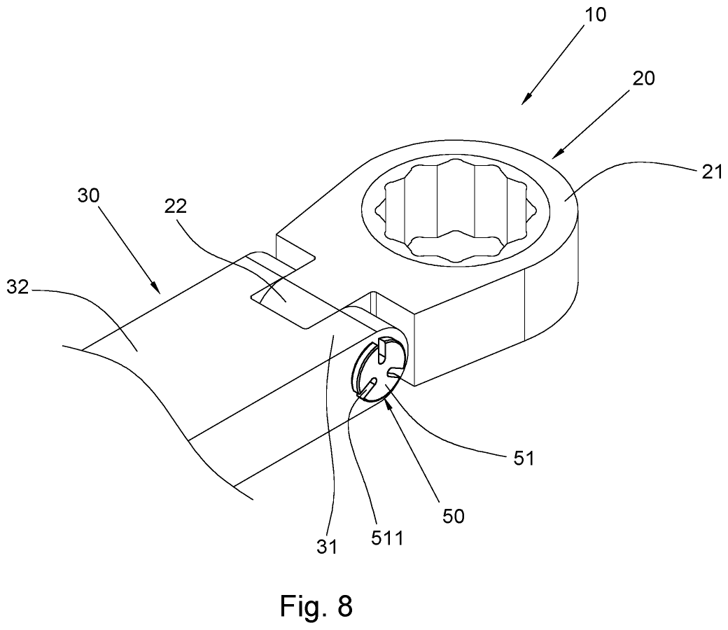

Please refer to FIG. 8, showing a fourth preferred embodiment of the present invention, and its main structure is identical to that of the first embodiment. In addition, for identical components, the same component signs are used accordingly, and details thereof are omitted hereafter.

On the stopping portion 51 of the shaft 50, the force exertion surface 511 includes three radial slots formed thereon, and such radial slots are provided for locking and attachment of a tool in order to secure the shaft 50.

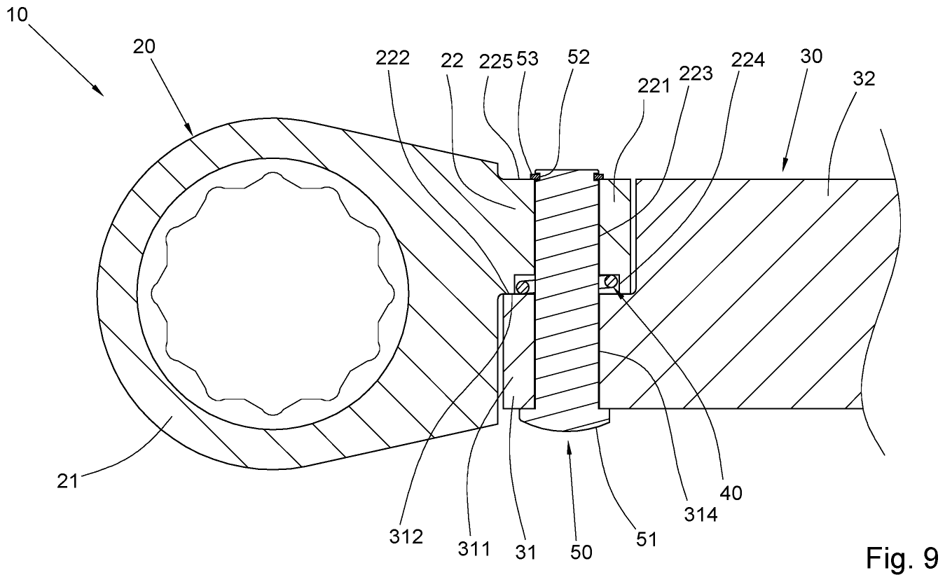

Please refer to FIG. 9, showing a fifth preferred embodiment of the present invention, and its main structure is identical to that of the first embodiment. In addition, for identical components, the same component signs are used accordingly, and details thereof are omitted hereafter.

The first connecting portion 22 of the first connector 20 and the second connecting portion 31 of the second connector 30 may also be formed of a first lug 221 and a second lug 311 only. The first lug 221 uses a first connecting surface 222 for connecting to a second connecting surface 312 of the second lug 311. The outer sides of the first lug 211 and the second lug 311 are formed of an installation surface 225, 313 respectively. Regardless of the variation in the quantity of the first lug 221 and the second lug 311, the engagement surface between the first lug 221 and the second lug 311 is able to form the first connecting surface 222 and the second connecting surface 312 respectively. The two most outer sides are then formed of the installation surfaces.

For the hinge structure provided by the present invention, its shaft avoids unnecessary structural components at the force exertion location such that its strength for force exertion is increased while preventing damages during the force exertion. In comparison to known shaft that requires further processing at the surface or internal for the formation of an assembly structure, leading to damage of the overall structure and reduction of the strength of the shaft, the present invention is able to significantly increase the operating strength.

The aforementioned embodiments are provided to illustrate the technical features of the present invention only such that the scope of the present invention shall not be limited to such embodiments only. Any equivalent modifications of the present invention shall be treated to be within the scope of claim of the present invention. The hinge structure of the present invention is a novel structure in this technical field and demonstrates practical effect, and an application is hereby submitted in accordance with the law.

What is claimed is:

1. A hinge structure of a hand tool, comprising:
a first connector having one end formed of a first connecting portion; the first connecting portion having at least one first lug, and each one of the first lugs having a first through hole formed thereon;
a second connector having one end formed of a second connecting portion; the second connecting portion having at least one second lug, and each one of the second lugs having a second through hole, such that when the first connecting portion being engaged with the second connecting portion, each one of the first through holes being overlapped with each one of the second through holes; and
a shaft having one end formed of a stopping portion protruded therefrom and another end circumferentially formed of a locking slot; the locking slot having a locking member elastically locked thereon; the shaft configured to penetrate each one of the first through holes and each one of the second through holes from one side, allowing the locking slot to penetrate out from another side surface; the locking member arranged to elastically locked inside the locking slot, thereby allowing the stopping portion and the locking member to lock onto each one of the first connecting portions and each one of the second connecting portions.

2. The hinge structure according to claim 1, wherein the shaft includes an attachment slot formed to indent inward at an end surface and in an axial direction; an anti-dust cover having an attachment rod and a cover portion; the attachment rod is arranged inside the attachment slot such that the cover portion covers the shaft; a depth of the attachment slot is shorter than a length of the first through hole or the second through hole connected thereto.

3. The hinge structure according to claim 1, wherein the stopping portion includes a force exertion surface formed thereon.

4. The hinge structure according to claim 3, wherein the force exertion surface includes a plurality of planes arranged spaced apart from each other form on an outer circumference of the stopping portion.

5. The hinge structure according to claim 1, wherein the first connector includes a head portion, and the second connector includes a handle portion.

6. The hinge structure according to any one of claims 1 to 5, wherein the first connecting portion includes at least one first lug, and the first lug includes a first connecting surface formed at two side surfaces of the through hole respectively; the second connecting portion includes at least two lugs arranged spaced apart from each other; each one of the first lugs is arranged between the two lugs; an engagement area between the second lugs and the first lug is formed of a second connecting surface; the second connecting portion includes an installation surface formed at an outer surface of an outer side of the two outer lugs at an outer most side respectively; the stopping portion and the locking member are locked onto the installation surface respectively.

7. The hinge structure according to any one of claims 1 to 5, wherein one of the first lugs of the first pivot or one of the second lugs of the second pivot include a receiving slot formed to indent inward at the engagement area; an elastic member includes a through hole for the shaft to penetrate there through and being received inside the receiving slot.

8. The hinge structure according to claim 1, wherein the at least one installation surface includes a groove formed to indent inward thereon, and the locking slot of the shaft is located at a bottom of the groove.
